(19) United States
(12) Patent Application Publication
(10) Pub. No.: US 2014/0291898 A1
(43) Pub. Date: Oct. 2, 2014

(54) METHOD OF FORMING A POROUS SINTERED CERAMIC BODY

(71) Applicant: Saint Gobain Ceramics & Plastics, Inc., Worcester, MA (US)

(72) Inventors: Vimal K. PUJARI, Northborough, MA (US); Nikolas J. NINOS, Kenmore, NY (US)

(21) Appl. No.: 14/301,935

(22) Filed: Jun. 11, 2014

Related U.S. Application Data
(62) Division of application No. 12/841,420, filed on Jul. 22, 2010, now abandoned.
(60) Provisional application No. 61/271,739, filed on Jul. 24, 2009.

(51) Int. Cl. C04B 38/06

(52) U.S. Cl. CPC C04B 38/0615
USPC 264/628

(57) ABSTRACT

A porous sintered silicon carbide body that includes a ceramic and a solid lubricant and methods of making thereof are described. The porous silicon carbide body can be a seal. The porous sintered silicon carbide body defines pores that can have an average pore size in a range of between about 20 μm and about 40 μm, and a porosity in a range of between about 1% and about 6% by volume.

### CROSS-REFERENCE TO RELATED APPLICATIONS

This Application claims priority under 35 U.S.C. §120 to and is a divisional application of U.S. patent application Ser. No. 12/841,420 entitled “Dry and Wet Low Friction Silicon Carbide Seal” by Pujari et al, filed Jul. 22, 2010, which claims priority under 35 U.S.C. §119(e) to U.S. Provisional Application No. 61/271,739 entitled “Dry and Wet Low Friction Silicon Carbide Seal” by Pujari et al., filed on Jul. 24, 2009. The above-referenced applications are incorporated herein by reference in their entireties.

### BACKGROUND

Ceramic materials such as silicon carbide have found particular use in a variety of industrial applications due to properties such as corrosion resistance and wear resistance. Such ceramic materials, however, do not have sufficient lubricity for some applications. Therefore, graphite loading has been incorporated in an attempt to improve the friction properties, particularly lubricity at elevated temperatures. See U.S. Pat. No. 6,953,760 issued to Pujari et al. on Oct. 11, 2005. Such ceramic components have found practical use as seals in dry environments and wet environments, such as, for example, automotive water pump seals.

Automotive water pump seals need to operate in both dry and wet environments to be effective. Graphite loading, however, improves the lubricity of a ceramic component in dry environments, but does not sufficiently improve the lubricity of the component in a wet environment. Therefore, there is a need for a ceramic component with improved tribological properties under both wet and dry operation.

### SUMMARY

The disclosure is generally directed to a porous sintered silicon carbide body comprising silicon carbide and graphite and to methods of making thereof. In some embodiments, the porous silicon carbide body is a seal. In certain embodiments, the porous sintered silicon carbide body defines pores with an average pore size in a range of between about 20 μm and about 40 μm comprising a porosity in a range of between about 1% and about 5% by volume.

In another embodiment, a method of forming a porous sintered ceramic body includes mixing ceramic powder with a sintering aid to form a ceramic mixture and combining a granulated mixture of ceramic and graphite with polymer beads and with the ceramic mixture to form a green mixture. In certain embodiments, the ceramic mixture can include silicon carbide, and the solid lubricant can include graphite. In other embodiments, the ceramic mixture can include zirconia. In still other embodiments, the ceramic mixture can include alumina In certain embodiments, the solid lubricant can include boron nitride. The method further includes shaping the green mixture into a green body and sintering the green body in an atmosphere in which it is substantially inert and at a temperature at which the polymer decomposes at least in part into gaseous products, thereby forming a porous sintered ceramic body. The granulated mixture can include silicon carbide and graphite in a weight ratio in a range of between about 1:1 and about 2:1. The sintering aid can include an amount of boron carbide in a range of between about 0.25 wt % and about 1 wt % and also includes an amount of carbon in a range of between about 1 wt % and about 5 wt %. The granulated mixture of silicon carbide and graphite can be present in the green mixture in an amount in a range of between about 1 wt % and about 15 wt %. The granulated mixture of silicon carbide and graphite can have an average particle size in a range of between about 10 μm and about 100 μm. The polymer beads can include polymethylmethacrylate, polyethylene, polypropylene, or any combination thereof. The polymer beads can be present in the green mixture in an amount in a range of between about 1 wt % and about 5 wt %, and the polymer beads can have an average particle size in a range of between about 10 μm and about 80 μm. The polymer beads can be present in the green mixture in an amount in a range of between about 1 wt % and about 3 wt %. The step of sintering the green body can be conducted at a temperature in a range of between about 2125 ° C. and to about 2250 ° C., for a time period in a range of between of one hour and about five hours. The porous ceramic body can define pores with an average pore size in a range of between about 20 μm and about 40 μm, comprising a porosity in a range of between about 1% and about 5% by volume.

Embodiments have many advantages, including improved tribological properties under both wet and dry conditions, and improved thermal conductivity and thermal shock resistance under transient dry running conditions. Various suitable seal applications include high pressure pumps, compressors, etc., where both dry and wet lubrication is desired.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a process flow process flow representing a particular fabrication technique according to an embodiment to provide a ceramic component.

FIG. 2 is a photomicrograph of a porous sintered silicon carbide body produced by the process shown in FIG. 1.

### DETAILED DESCRIPTION

A description of example embodiments follows. Silicon carbide (SiC) powder containing about 0.5 wt % B₄C and about 5 wt % carbon (as phenolic resin) is modified by addition of 1-10 wt % graphite (flake size 2-15 μm) and 1-5 wt % polymer (such as, for example, polymethylmethacrylate (PMMA)) beads (size range 10-80 μm). More preferred graphite and polymer bead contents are in the range 1-6 wt % and 1-3 wt % respectively. Subsequent to sintering the SiC microstructure contains clusters of graphite and pores (due to the pyrolysis of polymer beads) comprising a porosity in a range of between about 1% and about 5% by volume. The graphite inclusions and pores are expected to provide dry and wet lubrication at the mating seal pair interface. This seal material can be mated against itself or against a monolithic SiC seal containing only pores or graphite or neither of the two. Alternatively, the above approach can also be applied to a silicon carbide powder containing an oxide as a sintering aid, such as, for example, a rare earth oxide, Al₂O₃, MgO, TiO₂, or a combination thereof.

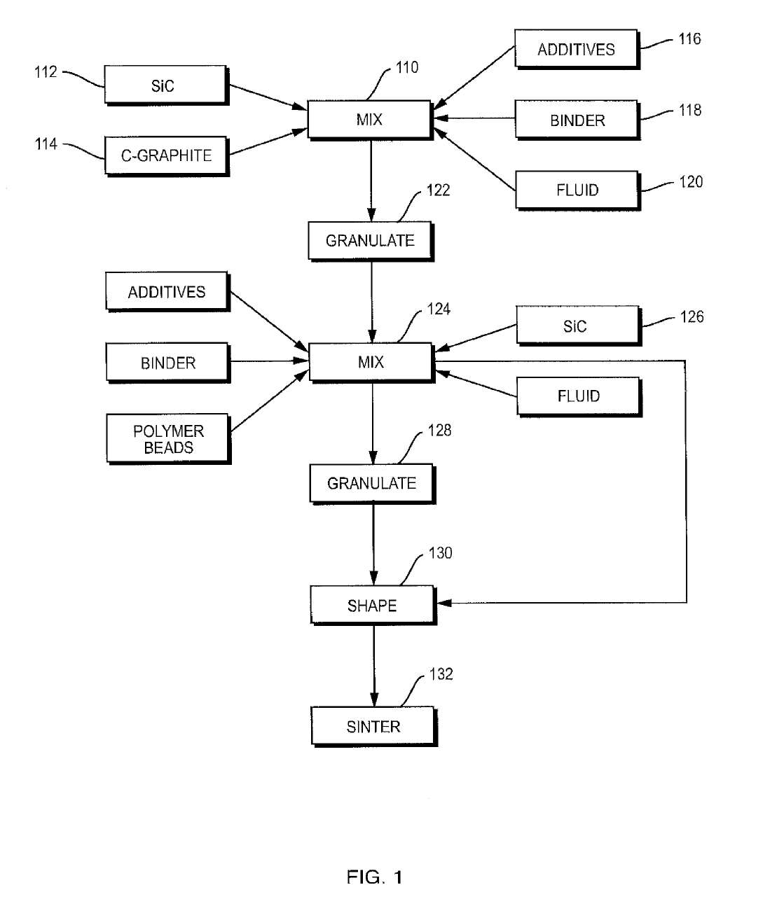

According to embodiments, various techniques for forming ceramic bodies, and in particular, lubricious and/or graphite-containing ceramic bodies are provided, as well as ceramic bodies formed thereby. In this regard, turning to FIG. 1, a process for forming a ceramic body according to an embodiment is depicted. First, various materials are mixed together at mixing step 110. Typically, the materials are mixed together to form a slurry, and include silicon carbide 112, typically in powder form containing fine particles, and carbon graphite 114, also typically in powder form containing fine particles. As is understood in the art, the graphite form of carbon has a particular platy or layered crystal structure in which carbon atoms in a graphitic plane are held together by strongly directional covalent bonds in a hexagonal array, and bonding between layers is provided by weak Van der Waals forces. Without wishing to be bound to any particular theory, it is believed that this crystal structure largely contributes to the lubricious nature of the graphite. The silicon carbide can be alpha, beta, or combination of alpha and beta silicon carbide.

The particle size of the carbon material may vary widely, such as from a sub-micron particle size to about 30 μm, most typically about 1 to about 20 μm. Similarly, particle size of the silicon carbide can also vary, such as on the order of 0.1 μm to about 20 μm, typically on the order of about 0.05 μm to about 5.0 μm. Particular embodiments utilize silicon carbide powder having a particle size on the order of about 1 μm.

Further, sintering and/or processing additives 116 can be added to the mixture, as well as any binders 118 and a fluid 120. Exemplary sintering aids include boron and carbon-based sintering aids. Particular examples include boron added as B₄C, whereas a carbon sintering aid can be derived from any carbon containing polymer such as phenolic resin. Exemplary concentrations include 0.5 wt % boron and 3.0 wt % carbon.

The weight percentage of the carbon can be reduced such as on the order of 1.0 to 2.0 wt % through reduction in phenolic resin. However, in such a case additional binders for green strength may have to be added. Typically, fluid 120 is water, forming an aqueous mixture also known as a slurry. The silicon carbide 112 can be present within a range of about 5 wt % to about 65 wt % with respect to the total of silicon carbide 112 and graphite 114, leaving graphite present within a range of about 35 wt % to about 95 wt % with respect to the total of silicon carbide and graphite. Most typically, silicon carbide is present in an amount of about 10 wt % to about 50 wt %, the balance being substantially graphite.

After formation of a stable slurry at mixing step 110, the slurry is granulated to form composite granules containing the major components silicon carbide 112 and graphite 114, as well as any processing/sintering additives 116 and binders 118. Granulation at step 122 can be carried out by various techniques, the most commonly used technique being spray-drying, well understood in the art. In addition to spray drying, the composite granules can be formed by casting, such as drip casting, also understood in the art.

The granulating step is carried out such that the composite granules have an average granule size within a range of about 10 microns (μm) to about 400 μm, typically about 10 μm to about 200 μm, and even more typically, about 20 μm to about 150 μm. The composite granules are stable agglomerates that contain two main phases, that of the silicon carbide raw material and the graphite raw material.

Following formation of the composite granules, the granules are mixed with additional components, including polymer beads, at mixing step 124. As with mixing step 110, the polymer beads, sintering/processing additives, binders and a fluid (typically water) are mixed to form a slurry containing the composite granules from granulating step 122. In addition, silicon carbide is also added to the slurry. The silicon carbide 126 may be formed of essentially the same material as silicon carbide 112. As such, the silicon carbide is generally in powder form, and may include alpha silicon carbide, beta silicon carbide, or mixtures thereof. Relative weight percentage of composite granules in the mixture is generally not greater than about 35 wt % of the total of the silicon carbide 126 and the composite granules. Accordingly, the composite granules, forming inclusions, generally make up not greater than about 35 wt % of the final form of the ceramic component according to embodiments. Most typically, the composite granules are present in an amount not greater than about 25 wt %, and generally within a range of about 5 wt % to about 25 wt %.

After formation of a slurry by mixing step 124, the slurry is generally granulated according to step 128 to form secondary granules, in similar fashion to step 122. As with granulating step 122, granulating at step 128 is typically carried out by spray drying, although alternative forms of granulating may be carried out. The resulting secondary granules from granulating step 128 generally comprise the SiC/C composite granules, thickly coated with SiC from the SiC source 128.

Alternatively, the mixing step 124 may be done entirely in the dry state, involving mixing of the silicon carbide material 126 with the composite granules from step 122 to form an intimate dry mixture, for subsequent shaping at shaping step 130.

In this regard, the granulating step 128 is bypassed, and generally the silicon carbide 126 would also be in granulated form for uniform mixing with the composite granules from step 122. In this case, the granules forming silicon carbide 126 would generally contain desired sintering/processing additives and binders, in a similar fashion to the composite granules formed at step 122.

At shaping step 130, either the dry mixture formed at step 124 or the granulated product formed at step 128 is shaped to form a green body for sintering at step 132. Various shaping techniques may be employed, most common of which include pressing, such as die pressing at room temperature, also known as cold pressing. Cold isostatic pressing (CIP), extrusion, injection molding and gel casting are other techniques used to form green bodies prior to sintering. Following shaping, the shaped body is sintered at step 132 to densify the shaped body, for a time period in a range of about 1 hour to about 5 hours. Sintering may be carried out by pressureless sintering, such as at a temperature within a range of about 1850° C. to about 2350° C., such as 2125° C. to about 2250° C. Sintering may also be carried out in an environment in which the shaped body is subjected to an elevated pressure, such as hot pressing and hot isostatic pressing, at a pressures in a range of about 4,000 lb/int (4 KSI) to about 30 KSI. In these cases, the sintering temperature can be lowered due to the addition of pressure, whereby densification can be carried out at lower temperatures. Sintering can be carried out in an inert environment, such as a noble gas or nitrogen.

The ceramic component formed as a result of the foregoing process flow generally contains a global continuous matrix phase forming a sintered ceramic body, the global matrix phase having a composition including the ceramic material incorporated at mixing step 124, and pores of about 40 μm average diameter. In the embodiment described above, that material is silicon carbide 126. While the foregoing embodiment focused on formation of a ceramic body having a composition comprising silicon carbide, other base materials such as zirconia (ZrO₂), and alumina (Al₂O₃), and combinations thereof may also be utilized depending upon the end use of the ceramic component. Most typically, ceramic material added at the mixing step 110 along with graphite 114 is generally the same as ceramic material incorporated at mixing step 124. In accordance with the foregoing embodiment, that same material is silicon carbide, although materials such as zirconia and alumina may also be utilized, as noted above.

Further, certain embodiments contemplate utilization of precursor material that is used to form the composite granules, which is a precursor to the desired final ceramic material. By way of example, silicon carbide 112 may be substituted with silica (SiO₂), which converts to silicon carbide during the high temperature sintering operation.

The ceramic component formed following sintering has a plurality of inclusions dispersed in the global matrix phase of the ceramic body, each inclusion including a graphite phase and a ceramic phase and defining a graphite-rich region. In the embodiment described above, the ceramic phase of the inclusions is silicon carbide. The inclusions are easily identifiable as such in the finally formed ceramic component, such as by any one of various known characterization techniques including scanning electron microscopy. The inclusions typically have an average size within a range of about 10 to about 400 microns, such as within a range of about 20 to 200 microns. Particular embodiments have inclusions having an average size within a range of about 30 to 150 microns. Particular working embodiments have been found to have 75 to 100 micron inclusions.

This ceramic component typically has a relatively high density, greater than about 85%, most typically greater than about 90% of the theoretical density (TD) of silicon carbide. Particular examples have demonstrated even higher densities, such as greater than 93% and even greater than 95% TD.

Typically, the overall content of the graphite in the ceramic component falls within a range of about 2 wt % to about 20 wt % graphite, such as within a range of about 5 wt % to about 15 wt % graphite. According to a particular feature, the inclusions have essentially a multi-phase structure including a first phase formed of the ceramic material such as silicon carbide 112, which forms an interconnected inclusion matrix phase which has a skeletal structure, in which the graphite is embedded. This skeletal structure or continuous matrix phase of ceramic material of the inclusions advantageously functions to anchor the graphite (or other lubricious material, such as, for example, boron nitride) in each inclusion, improving the mechanical stability of the graphite.

### EXEMPLIFICATION

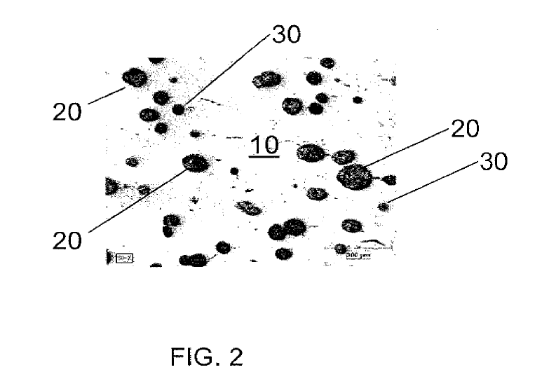

A 50% SiC and 50% graphite mixture prepared according to the procedure described above was first pre-granulated into so called SA/G granules (50-60 μm) and cured prior to addition to the SiC slurry. More specifically to an aqueous suspension of 12 wt % phenolic resin, SiC and graphite flakes were added in the ratio of about 50/50 with a total solids loading of about 30 wt %. The slurry pH was maintained at about 9.5. After high shear mixing, the slurry was spray dried into 60-80 μm granules and cured at about 300° C. for about 4 hours in Argon. The cured SA/G granules were once again added to an aqueous SiC suspension containing 40 μm beads. This suspension contained about 50% solids consisting of 85 wt % SiC, 12 wt % SA/G and 3 wt % PMMA granules. This suspension was once again spray dried to granules in the size range of about 80-100 μm. The spray dried powder so produced, containing SA/G granules and PMMA beads, was pressed (4-30KSI) and sintered in the temperature range of about 2125-2250° C. for about 1-5 hours in Argon or Nitrogen gas environment. The sintered silicon carbide composite microstructure so produced had a density in the range of about 94-96% TD without interconnected porosity thus making it suitable as a seal material. Turning now to FIG. 2, silicon carbide matrix 10 contained granules 20 of about 50/50 wt % graphite/SiC and pores 30, with an average pore size in a range of between about 20 μm and about 40 μm. The teachings of all patents, published applications and references cited herein are incorporated by reference in their entirety.

### EQUIVALENTS

While embodiments have been particularly shown and described with references to example embodiments thereof, it will be understood by those skilled in the art that various changes in form and details may be made therein without departing from the scope of the invention encompassed by the appended claims.

What is claimed is:

1. A method of forming a porous sintered ceramic body comprising:
mixing a ceramic powder with a sintering aid to form a ceramic mixture;
combining a granulated mixture of a ceramic and a solid lubricant with polymer beads and with the ceramic mixture to form a green mixture;
shaping the green mixture into a green body; and
sintering the green body at a temperature at which the polymer decomposes at least in part into gaseous products, to form the porous sintered ceramic body defining pores with an average pore size in a range of about 20 μm to about 40 μm and a porosity in a range of about 1% to about 6% by volume.

2. The method of claim 1, wherein the porous sintered ceramic body is without interconnected porosity.

3. The method of claim 1, wherein the ceramic powder comprises silicon carbide.

4. The method of claim 1, wherein sintering the green body is performed in an atmosphere that is substantially inert.

5. The method of claim 4, wherein the ceramic powder comprises silica, and during sintering, the silica converts to silicon carbide.

6. The method of claim 1, wherein the solid lubricant comprises graphite.

7. The method of claim 1, wherein the granulated mixture includes silicon carbide and graphite in a weight ratio in a range of between about 1:1 and about 2:1.

8. The method of claim 1, wherein the granule mixture is in a form of granules having an average granule size within a range of about 20 μm to about 400 μm.

9. The method of claim 1, wherein granules of the granulated mixture is not greater than about 35 wt % of a mass of the green mixture.

10. The method of claim 1, wherein the polymer beads include polymethylmethacrylate, polyethylene, polypropylene, or any combination thereof.

11. The method of claim 1, wherein the polymer beads have an average particle size in a range of about 20 μm to about 80 μm.

12. The method of claim 11, wherein the polymer beads are present in the green mixture in an amount in a range of about 1 wt % to about 5 wt %.

13. The method of claim 1, wherein sintering is performed as pressureless sintering.

14. The method of claim 1, wherein sintering is performed at a pressure in a range of about 4 KSI to about 30 KSI.

15. The method of claim 1, wherein the porous sintered ceramic body comprises inclusions having an average size within a range of about 30 μm to about 150 μm.

16. The method of claim 1, wherein the porous sintered ceramic body is a seal.

17. A method of forming a porous sintered ceramic body without interconnected porosity, comprising:
combining polymer beads with a ceramic powder, a solid lubricant, and a sintering aid to form a green mixture;
shaping the green mixture into a green body; and
sintering the green body in an atmosphere in which it is substantially inert and at a temperature at which the polymer decomposes at least in part into gaseous products, to form the porous sintered ceramic body without interconnected porosity.

18. The method of claim 16, wherein the porous sintered ceramic body defines pores with an average pore size in a range of about 20 μm to about 40 μm.

19. The method of claim 16, wherein the porous sintered ceramic body defines pores comprising a porosity in a range of between about 1% to about 6% by volume.

20. The method of claim 16, wherein:
the polymer beads have an average particle size in a range of about 20 μm to about 80 μm and are present in the green mixture in an amount in a range of about 1 wt % to about 5 wt %;
the ceramic powder includes silicon carbide;
the solid lubricant includes graphite; and
the porous sintered ceramic body:
comprises inclusions having an average size of having an average size within a range of about 30 μm to about 150 μm, and a mass in a range of about 5 wt % to 35 wt % of a mass of the porous sintered ceramic body;
defines pores comprising a porosity in a range of between about 1% to about 5% by volume, wherein the pores have an average pore size in a range of about 20 μm to about 40 μm; and
is a seal adapted for dry and wet environments.
